(19) United States
(12) Patent Application Publication
(10) Pub. No.: US 2013/0266693 A1
(43) Pub. Date: Oct. 10, 2013

(54) SOLUBLE MILK-BASED TABLET SURFACE-TREATED WITH CARBOHYDRATE

(71) Applicants: Ursula Leuenberger, Thun (CH); Christian Schmied, Konolfingen (CH); Peter Zeltner, Worblaufen (CH)

(72) Inventors: Ursula Leuenberger, Thun (CH); Christian Schmied, Konolfingen (CH); Peter Zeltner, Worblaufen (CH)

(73) Assignee: NESTEC S.A., Vevey (CH)

(21) Appl. No.: 13/994,990

(22) PCT Filed: Dec. 16, 2011
(86) PCT No.: PCT/EP11/73055

§ 371 Date: Jun. 17, 2013

(30) Foreign Application Priority Data
Dec. 16, 2010 (EP) 10195451.9

(51) Int. Cl. A23C 9/18

(52) U.S. Cl. CPC A23C 9/18
USPC 426/61; 426/302; 426/103

(57) ABSTRACT

The present invention relates to a method for the manufacture of soluble milk-based tablets and in particular to milk-based tablets surface-treated with a carbohydrate. The invention also relates to the use of a concentrated carbohydrate solution to re-duce a friability of a milk-based tablet. The soluble milk-based tablet surface-treated with the carbohydrate has applications in the beverage industry.

### FIELD OF INVENTION

The present invention relates to a method for the manufacture of soluble milk-based tablets and in particular to soluble milk-based tablets surface-treated with a carbohydrate.

### BACKGROUND OF THE INVENTION

Milk-based powders are used extensively in beverages such as coffee and tea. The milk-based powders are used as a substitute for fresh milk in the beverages.

The milk-based powders have a long shelf-life in comparison to fresh milk because most of the moisture for microbial growth is removed. The removal of moisture results in a porous milk-based powder that readily dissolves in the beverages.

Milk-based powders are stored in containers and need to be spooned into the beverages. A drawback of milk-based powders is that they are not readily transportable and not useful for “on-the-go” situations. Milk-based tablets however address some of the shortcoming of milk-based powders.

EP 1 048 216 discloses a method for the manufacture of a densified milk product i.e milk-based tablets.

EP 1 769 682 discloses a solid milk product and a method for the manufacture of the solid milk product. In particular a solid milk product in which a porosity of the solid milk product is controlled so that the solid milk product has a preferred solubility, a preferred strength and in which fat float-off is avoided when the solid milk product it is added to a beverage.

WO 2007/077970 discloses a solid milk product and a method for the manufacture of the solid milk product. In particular a solid milk product in which a porosity of the solid milk product is controlled so that the solid milk product has a preferred solubility, a preferred strength and in which fat float-off is avoided when the solid milk product is added to a beverage.

EP 0 169 319 relates, inter alia, to food tablet coated on its exterior surfaces with maltodextrin, in order to mask the taste of the table ingredient and does not have a slimy taste. The objective achieved according to this document is to avoid contact between the tablet ingredient and the taste buds. This document does not discuss dissolution of the tablet into water, prior to consumption of the product.

Milk-based tablets such as those described in the prior art are friable substances. This means that the milk-based tablets can be easily reduced to their constituent milk-based powders by an action of pressure or friction on the milk-based tablet. Therefore the milk-based tablets of the prior art are cumbersome to handle and very easily damaged. The milk-based tablets of the prior art need special packaging and special handling to prevent them from becoming damaged and forming their constituent milk-based powders.

There is a need to reduce a friability of milk-based tablets whilst retaining the physical properties such as a dissolution rate, strength and flavour of the milk-based tablets.

There is a need to overcome at least some of the problems associated with the prior art.

### SUMMARY OF INVENTION

In a first aspect the present invention relates to a method for the manufacture of a soluble milk-based tablet. In particular a soluble milk-based tablet that has been surface-treated with carbohydrate.

In a further aspect the present invention relates to a soluble milk-based tablet surface-treated with a carbohydrate.

In a further aspect the present invention relates to a container comprising at least one soluble milk-based tablet surface-treated with a carbohydrate.

In a further aspect the present invention relates to a use of a carbohydrate for reducing a friability of a soluble milk-based tablet.

### DETAILED DESCRIPTION OF INVENTION

The present inventors have found that a surface treatment of a soluble milk-based tablet according to the present invention provides robust tablet for packaging, handling while providing good dissolution behaviours in liquid and with use of standard compression equipment.

A milk-based tablet as described herein refers to a milk-based powder that has been densified and molded into a form. Within the context of the invention, “milk-based powder” and “milk-based tablet” mean respectively a powder and a tablet that comprise one or several milk components, such as proteins, including caseins and derivatives, carbohydrates, including lactose, or milk fats, as well as a powder and a tablet that can be used as a milk substitute. Milk substitutes include non-dairy milk powder.

As used herein, “soluble” milk-based tablet refers to the fact that the tablet can dissolve rapidly in an aqueous medium such as water, milk, fruit juice, coffee, tea, or other beverages, for consumption at cold, ambient, warm or hot temperatures (i.e. from a few ° C. to about 90° C.). The reconstitution time of the soluble milk-based tablet in an aqueous medium is preferably between 15 and 120 sec.

Densification refers to a compression, a compaction, a granulation, a spheronisation or any other procedure for reducing a volume of the milk-based powder by a certain percentage by compressing the milk-based powder. Densification (or degree of compaction) is a measure of a reduction in a volume of the milk-based powder compared with a volume of the milk-based tablet.

A method for the manufacture of the soluble milk-based tablet surface-treated with a carbohydrate is described below.

In a first step a wet agglomeration of a milk-based powder is formed. The milk-based powder can be obtained by spray-drying, freeze-drying or any other procedure of drying known in the art. The milk-based powder can include a milk powder derived from a whole milk powder, a partially skimmed milk powder, a skimmed milk powder, a filled milk powder, an adapted milk powder a cream powder or a coffee enhancer. The milk-based powder can also be a combination of the milk powder with cocoa, chocolate, coffee and non-dairy milk powder or mixtures thereof.

A total fat content of the milk-based tablet is preferably between 15 and 40%. The fat can be milk fat, endogenous fat, vegetable fat or animal fats or the fat can be any combinations thereof. The whole milk powder is milk powder that contains 26% fat or more. The partially skimmed milk powder is milk powder that contains between 1.5 and 26% fat. The skimmed milk powder is milk powder with less than 1.5% fat. The filled milk powder is the skimmed milk powder with additional vegetable fat. By non-dairy milk powder it is meant a partially or totally synthetic milk powder, for example but limited to a coffee whitener.

The wet agglomeration of the milk-based powder is carried out by applying a liquid to wet the milk-based powder. The liquid may be applied to wet the milk-based powder by the use of nozzles that spray the liquid onto the milk-based powder. The liquid is usually demineralised water and can also be a solution of sugars, colorants and flavourings in the demineralised water or an emulsion such as reconstituted milk-based. The liquid may also include some additives.

The additives can be a binding agent, a stabilising agent, an emulsifying agent, probiotics and a wetting agent or any mixtures thereof. The binding agent can be for example a maltodextrin, such as a glucose syrup, a caseinate, an alginate or a carragheenan. The stabilising agent can be for example an alginate or a carragheenan. The emulsifying agent can be for example a lecithin, a caseinate or a glycerolester. The amount of the additives in the milk-based tablet is between 0 and 10%.

The wet agglomeration of the milk-based powder results a wet agglomerate of the milk-based powder with a moisture content of between 3 and 10%, preferably the wet agglomerate of the milk-based powder has a moisture content of between 4 and 8%.

The wet agglomeration of the milk-based powder can be carried out using an apparatus known in the art, for example, a drum or a fluidised bed.

In a second step the wet agglomerate of the milk-based powder can be sieved with a sieving device to form a sieved wet agglomerate of the milk-based powder. A diameter of a mesh opening of the sieving device is preferably between 0.5 and 3 mm. It is most preferable that a diameter of the mesh opening of the sieving device is 2 mm.

In a third step the sieved wet agglomerate of the milk-based powder can be fed into a tabletting machine for compaction.

In fourth step the wet agglomerate of the milk-based powder is compacted to form the soluble milk-based tablet. The compaction is a two step process:
a pre-compaction step wherein the wet agglomerate of the milk-based powder can be first compacted at a force of between 0.2 and 0.6 kN.
A main-compaction step where the wet agglomerate of the milk-based powder is then compacted at a force of between 1 and 10 kN.

Typically, throuput ranges from 600-1200 tablets/minute. Residence time under pressure is an important factor and must be adjusted as known in the art so that the compacted tablets have the required hardness (10-30N). As mentioned the compaction or densification is either carried out as a compression, a compaction or using any other device for reducing the volume of the wet agglomerate of the milk-based powder by a certain percentage. A device used for this compaction or densification can be for example a modified tabletting machine, a compacting machine as known in the art.

In a further step a drying of soluble milk-based tablet is performed. The drying is carried out by for example in an oven, using convection currents or in a vacuum. Following the drying step a moisture content of soluble milk-based tablet should be less than 4.0%, more preferably less than 3.0%.

At the end of the drying step, a surface treatment of the soluble milk-based tablet is carried out to form the soluble milk-based tablet surface-treated with the carbohydrate. A concentrated solution of carbohydrates is applied to the surface of the soluble milk-based tablet. In a preferred embodiment, mono and disaccharides are used. Sucrose, maltodextrin, glucose syrup are particularly preferred.

It is preferable that the concentrated carbohydrate solution has a dry matter of at least 20%, preferably between 20 and 80% dry matter, more preferably from 40 to 80%, even more preferably from 50 to 80%.

Additional functional ingredients can be added to the concentrated carbohydrate solution. The functional ingredient may be chosen among the list consisting of probiotic bacterium, prebiotic, vitamin, enzyme, antioxidant, mineral salt, amino-acid supplement, peptide, protein, gum, carbohydrate, phytochemical, dextrose, lecithin, other trace nutrient, botanical extract, flavours, aroma, fatty acid, oat beta glucan or other functional fibre, creatine, carnitine, bicarbonate, citrate, caffeine or any mixture thereof.

There are a variety of probiotic microorganisms which are suitable, in particular, having regard to activation of the immune system, prevention of the bacterial overgrowth by pathogens, prevention of diarrhoea and/or restoration of intestinal flora, for example. Probiotic microorganisms include yeast such as Bifidobacterium, Lactobacillus, Streptococcus, Saccharomyces. Preferably, the microorganism is in a spray dried or freeze-dried form.

More preferably, said probiotic bacterium may be selected from the group consisting of Lactobacillus johnsonii, Lactobacillus paracasei, Bifidobacterium longum, Bifidobacterium adolescentis, and Bifidobacterium lactis.

The amount of probiotics may vary according to the specific needs. However, in a preferred embodiment, the amount of lactic acid bacterium in one soluble milk-based tablet is 10E2 to 10E12 count/gram, more preferably from 10E7 to 10E11 count/gram, even more preferably 10E8 to 10E1 count/gram. The amount per gram of bacterium in one product is preferably determined upon the recommended daily dosage based on the number of products to be consumed per day.

The functional ingredient may preferably be (micro) encapsulated in order to increase its stability and maintain its viability. (Micro) encapsulation means the incorporation of the functional ingredients in small (micro) capsules by various known techniques such as spray drying, spray chilling or spray cooling, extrusion coating, fludised bed coating, liposome entrapment, coacervation, inclusion complexation, centrifugal extrusion and rotational suspension separation. The encapsulating material may be any one or more among the following list: fats, starches, dextrins, alginates, proteins, and lipids. The encapsulation of the functional ingredient (s) may also provide the advantage to delay the release of the functional ingredient and/or to gradually release the functional ingredient (s) along an extensive period of time in the digestives sites; i.e., the mouth and/or gut.

Optionally, the soluble milk-based tablet surface-treated with the carbohydrate is then dried and/or cooled. The drying is carried out by for example in an oven, using convection currents or in a vacuum. The soluble milk-based tablet surface-treated with the carbohydrate may then be cooled to ambient temperature.

The manufactured soluble milk-based tablet surface-treated with the carbohydrate can then be packaged in a suitable container. The container can be, for example, a stick pack (blister pack) that allows the dispersion of individual milk-based tablets surface-treated with the carbohydrate, the container can also be a jar.

It is observed that the milk-based tablets surface-treated with the carbohydrate according to the present invention are less friable. The friability of milk-based tablets not surface-treated with carbohydrate have a high friability of more than 20%. The milk-based tablets surface-treated with carbohydrate have a significantly reduced friability of about 15 to 10%, preferably less than 10%.

The surface treatment with the carbohydrate has no effect on a dissolution profile of the milk-based tablet surface-treated with a carbohydrate compared to a milk-based tablet non surface-treated with the carbohydrate as shown in the examples.

The reconstitution time of the soluble milk-based tablet in an aqueous medium is preferably between 15 and 120 sec. The reconstitution time depends on three factors. The three factors are a sinking time, a disintegration time and a dissolution time.

The reconstitution time is measured by dissolving the milk-based tablet in an aqueous medium at a specific temperature. The specific temperature depends on the type of milk-based powder used in the milk-based tablet; for example, with a skimmed milk powder, a temperature of the aqueous medium is 20° C.; with a whole milk powder, a temperature of the aqueous medium is 40° C. and with a non-dairy creamer, a temperature of the aqueous medium is 70° C. The dissolution time is the time taken for the milk-based tablet to dissolve in the aqueous medium. The dissolution time is preferably between 0 and 10 sec. The dissolution time is very important in the beverage industry.

The milk-based tablet has a breaking strength between 20 and 250 Newtons and preferably between 35 and 180 Newtons, to ensure that it will not disintegrate into a powder of its constituents for example by handling and transportation.

### EXAMPLES

The loose density and the absolute density of the milk-based tablet were measured using a Micromeritics Accupyc 1330—gas pycnometer and Geopyc. The loose density refers to a measure of a weight of the milk-based powder with air, per volume of the milk-based powder.

$$1 - \frac{Envelope density}{Tablet density}$$

Envelope density=Density of the whole tablet and its pores (g/cm³)
Tablet density=Absolute density of the whole tablet (g/cm³)

The breaking strength of the milk-based tablet was measured with a Caleva Tablet hardness tester (portable).

The wet agglomeration of the milk-based powder was carried out using a fluidised bed from Glatt.

The tabletting machine for forming the milk-based tablet was a Röltgen Flexitab single punch press or a Kilian KTS1000 double punch press.

The milk-based tablet surface-treated with carbohydrate were analysed with a Micromeritics Accupyc 1330 gas pycnometer and Geopyc.

### Example 1

### Surface Treatment of Milk Tablet

Carbohydrate solutions were prepared for surface-treating the milk-based tablets. The carbohydrate solutions were:
Sucrose solutions containing 50% dry matter sucrose.
Maltodextrin solutions containing 50% dry matter maltodextrin DE 29.

### Composition Base Powder:

TABLE 1

| | Base | Base | Base |
|---|---|---|---|
| | powder A: | Powder B: | Powder C: |
| Malto-Dextrine | 57 | 51 | 59 |
| Vegetable Fat | 34 | 35 | 33 |
| Caseinate | 2.5 | 1.4 | 2.3 |
| Stabilizers | 2.6 | 2.3 | 1.9 |
| Emulsifiers | 0.5 | 1 | 0.5 |
| Sucrose | | 7 | |

Surface-Treating Milk-Based Tablets with Sucrose

Milk-based tablets made of coffee whitener base A or B (Table 1, Base powder A or B) were sprayed with sucrose solutions (50% dry matter sucrose) as shown in tables 2 below.

Table 2a

| Trial 1 | Coffee whitener base A & sucrose solution 50%; Residence time 18 sec | | | | | | | | | |
|---|---|---|---|---|---|---|---|---|---|---|
| Tablet | 1 | 2 | 3 | 4 | 5 | 6 | 7 | 8 | 9 | 10 |
| Weight g | 3.18 | 3.16 | 3.18 | 3.18 | 3.18 | 3.19 | 3.17 | 3.18 | 3.18 | 3.18 |
| Weight aft. | 3.20 | 3.19 | 3.21 | 3.20 | 3.21 | 3.22 | 3.20 | 3.20 | 3.20 | 3.20 |
| drying | | | | | | | | | | |
| coating | 0.02 | 0.03 | 0.03 | 0.02 | 0.03 | 0.03 | 0.03 | 0.02 | 0.02 | 0.02 |

Table 2b

| Trial 2 | Coffee whitener base A & sucrose solution 50%; Residence time 23 sec | | | | | | | |
|---|---|---|---|---|---|---|---|---|
| Tablet | 1 | 2 | 3 | 4 | 5 | 6 | 7 | 8 |
| Weight g | 3.19 | 3.19 | 3.25 | 3.16 | 3.18 | 3.17 | 3.22 | 3.19 |
| Weight aft. | 3.21 | 3.22 | 3.27 | 3.20 | 3.21 | 3.19 | 3.25 | 3.21 |
| drying | | | | | | | | |
| coating | 0.02 | 0.03 | 0.02 | 0.04 | 0.03 | 0.02 | 0.03 | 0.02 |

Table 2c

| Trial 3 | Coffee whitener base B & sucrose solution 50%; Residence time 23 sec | | | | | | | | | |
|---|---|---|---|---|---|---|---|---|---|---|
| Tablet | 1 | 2 | 3 | 4 | 5 | 6 | 7 | 8 | 9 | 10 |
| Weight g | 3.21 | 3.24 | 3.19 | 3.23 | 3.21 | 3.21 | 3.22 | 3.24 | 3.21 | 3.25 |
| Weight aft. | 3.25 | 3.27 | 3.22 | 3.26 | 3.24 | 3.23 | 3.25 | 3.26 | 3.24 | 3.21 |
| drying | | | | | | | | | | |
| coating | 0.04 | 0.03 | 0.03 | 0.03 | 0.03 | 0.02 | 0.03 | 0.02 | 0.03 | 0.03 |

Table 2d

| Trial 4 | Coffee whitener base B & sucrose solution 50%; Residence time 30 sec | | | | | | | | | |
|---|---|---|---|---|---|---|---|---|---|---|
| Tablet | 1 | 2 | 3 | 4 | 5 | 6 | 7 | 8 | 9 | 10 |
| Weight g | 3.20 | 3.21 | 3.22 | 3.21 | 3.23 | 3.19 | 3.22 | 3.26 | 3.24 | 3.24 |
| Weight aft. | 3.24 | 3.26 | 3.25 | 3.26 | 3.26 | 3.23 | 3.26 | 3.31 | 3.28 | 3.28 |
| drying | | | | | | | | | | |
| coating | 0.04 | 0.05 | 0.03 | 0.05 | 0.03 | 0.04 | 0.04 | 0.05 | 0.04 | 0.04 |

Typical mass uptake for Base A 0.02-0.03 g (=<1%)
Typical mass uptake for Base B 0.02-0.03 g (=1-1.3%)
Surface-Treating Milk-Based Tablets with Maltodextrin

Soluble milk-based tablets made of coffee whitener base A or B (Table 1, Base powder A or B) were sprayed with maltodextrin solution (50% dry matter maltodextrin) as shown in tables 3 below.

Table 3a

| Trial 5 | Coffee whitener base A & MD DE29 solution 50%; Residence time 18 sec | | | | | | | | | |
|---|---|---|---|---|---|---|---|---|---|---|
| Tablet | 1 | 2 | 3 | 4 | 5 | 6 | 7 | 8 | 9 | 10 |
| Weight g | 3.18 | 3.20 | 3.20 | 3.19 | 3.17 | 3.18 | 3.18 | 3.20 | 3.16 | 3.18 |
| Weight aft. | 3.20 | 3.22 | 3.22 | 3.20 | 3.18 | 3.20 | 3.20 | 3.21 | 3.18 | 3.19 |
| drying | | | | | | | | | | |
| coating | 0.02 | 0.02 | 0.02 | 0.01 | 0.01 | 0.02 | 0.02 | 0.01 | 0.02 | 0.01 |

Table 3b

| Trial 6 | Coffee whitener base A & MD DE29 solution 50%; Residence time 23 sec | | | | | | | | | |
|---|---|---|---|---|---|---|---|---|---|---|
| Tablet | 1 | 2 | 3 | 4 | 5 | 6 | 7 | 8 | 9 | 10 |
| Weight g | 3.19 | 3.17 | 3.18 | 3.16 | 3.18 | 3.18 | 3.16 | 3.18 | 3.20 | 3.18 |
| Weight aft. | 3.20 | 3.18 | 3.19 | 3.18 | 3.19 | 3.20 | 3.18 | 3.19 | 3.21 | 3.19 |
| drying | | | | | | | | | | |
| coating | 0.01 | 0.01 | 0.01 | 0.02 | 0.01 | 0.02 | 0.02 | 0.01 | 0.01 | 0.01 |

Table 3c

| Trial 7 | Coffee whitener base B & MD DE29 solution 50%; Residence time 23 sec | | | | | | | | | |
|---|---|---|---|---|---|---|---|---|---|---|
| Tablet | 1 | 2 | 3 | 4 | 5 | 6 | 7 | 8 | 9 | 10 |
| Weight g | 3.24 | 3.23 | 3.22 | 3.21 | 3.21 | 3.20 | 3.23 | 3.19 | 3.22 | 3.25 |
| Weight aft. | 3.26 | 3.24 | 3.23 | 3.23 | 3.24 | 3.23 | 3.23 | 3.20 | 3.23 | 3.26 |
| drying | | | | | | | | | | |
| coating | 0.02 | 0.01 | 0.01 | 0.02 | 0.03 | 0.03 | 0.00 | 0.01 | 0.01 | 0.01 |

### Example 2

### Friability Analysis of Milk-Based Tablet Surface-Treated with Carbohydrate

A friability analysis of milk-based tablets surface-treated with carbohydrate prepared as in example 1, Trial 2(Table 2b) was made. As a reference a friability analysis of milk-based tablet not surface-treated with carbohydrate was also made. The results of the friability analysis are shown in Table 4 below.

TABLE 4

| | | After | After |
|---|---|---|---|
| | | coating | coating |
| | Whithout | Residence | Residence |
| | coating | time 23 sec. | time 60 sec |
| Friability % | 19.7 | 8.1 | 0.4 |

Base powder A

The friability is mainly perceived during handling the tablets i.e. by touch.

It is clear to see that the milk-based tablets not surface-treated with carbohydrate have a high friability 19.7%. This is in contrast to the milk-based tablets surface-treated with carbohydrate which has a significantly reduced friability of 8.1% and 0.4%.

### Example 3

### Dissolution Analysis of Milk-Based Tablets Surface-Treated with Carbohydrate

An analysis of dissolution properties of the milk-based tablet surface-treated with carbohydrate prepared as described below was made. This analysis was made to ensure that there is no negative effect of the surface treatment with carbohydrates on the milk-based tablet. The results are showed in Table 5 below.

TABLE 5
Dissolution tests
Coating: Residence time 23 sec Sugar solution 50%
Dissolution score: Range 0-5 (0 = no residue, 5 less than 50%
dissolveld)

| | Before Treatment | | After treatment | |
|---|---|---|---|---|
| | Sinking time | Dissolution | Sinking time | Dissolution |
| Base | sec | score | sec | score |
| A | 7 | 0.5 | 6 | 0 |
| | 6 | 0.5 | 4 | 0.5 |
| B | 8 | 0 | 6 | 0 |
| | 7 | 0 | 7 | 0 |
| C | 7 | 0.5 | 5 | 0.5 |
| | 7 | 0 | 6 | 0 |

It is clear to see that the surface treatment of milk-based tablets with carbohydrate does not have a negative effect on the dissolution properties of the milk-based tablets. This is important as the milk-based tablet surface-treated with carbohydrate has applications in the beverage industry and where the dissolution rates of milk-based tablets is very important.

1. A method for the manufacture of a soluble milk-based tablet surface-treated with a carbohydrate, the method comprising the steps of:
providing a soluble milk-based tablet; and
surface-treating the milk-based tablet with a concentrated carbohydrate solution to form the soluble milk-based tablet.

2. The method of claim 1, wherein the concentrated carbohydrate solution has a dry matter of at least 20%.

3. The method of claim 1, wherein the concentrated carbohydrate solution has a dry matter of from 40 to 80%.

4. The method of claim 1, wherein the concentrated carbohydrate solution comprises at least one of mono and disaccharides.

5. The method of claim 1, wherein the concentrated carbohydrate solution comprises at least one component selected from the group consisting of glucose syrup, sucrose and maltodextrin.

6. The method of claim 1, wherein the concentrated carbohydrate solution further comprises functional ingredients.

7. The method of claim 1, wherein the functional ingredients are selected from the group consisting of probiotic bacterium, probiotic bacterium, prebiotic, vitamin, enzyme, antioxidant, mineral salt, amino-acid supplement, peptide, protein, gum, carbohydrate, phytochemical, dextrose, lecithin, other trace nutrient, botanical extract, flavours, aroma, oat beta glucan or other functional fibre, creatine, carnitine, bicarbonate, citrate, caffeine and mixtures thereof.

8. The method of claim 1, wherein the milk-based tablet comprises a component selected from the group consisting of a whole milk powder, a skimmed milk powder, a partially skimmed milk powder, a filled milk powder, an adapted milk powder and a cream powder and mixtures thereof.

9. The method of claim 1, wherein the milk-based tablet comprises additives selected from the group consisting of a binding agent, a stabilising agent, an emulsifying agent, probiotics and a wetting agent and mixtures thereof.

10. A soluble milk-based tablet surface-treated with carbohydrate obtainable by providing a soluble milk-based tablet and surface-treating the milk-based tablet with a concentrated carbohydrate solution to form the soluble milk-based tablet.

11. A container comprising at least one soluble milk-based tablet surface-treated with carbohydrate the method comprising the steps of providing a soluble milk-based tablet, and surface-treating the milk-based tablet with a concentrated carbohydrate solution to form the soluble milk-based tablet.

12. A method for reducing a friability of a soluble milk-based tablet comprising the step of applying a carbohydrate to the surface of the milk-based tablet.

13. The use of claim 12 wherein the carbohydrate is a concentrated solution of carbohydrate comprising an ingredient selected from the group consisting of glucose syrup, sucrose and maltodextrin.
